(19) United States
(12) Patent Application Publication
(10) Pub. No.: US 2026/0128683 A1
(43) Pub. Date: May 7, 2026

(54) HIGH-VOLTAGE HIGH-SPEED SWITCHING APPARATUS FOR STABILIZING VOLTAGE OF HYDROGEN FUEL CELL AND CONTROL METHOD THEREOF

(71) Applicant: DESTIN POWER CO., LTD., Naju-si (KR)

(72) Inventors: Min Soo JANG, Seoul (KR); Kyung Choon LEE, Suwon-si (KR); Won Young JE, Suwon-si (KR); Tae Min JANG, Suwon-si (KR)

(73) Assignee: DESTIN POWER CO., LTD., Naju-si (KR)

(21) Appl. No.: 19/360,218

(22) Filed: Oct. 16, 2025

(30) Foreign Application Priority Data
Nov. 5, 2024 (KR) 10-2024-0155027

(51) Int. Cl. H02M 7/537; H02M 1/088

(52) U.S. Cl. CPC H02M 7/537; H02M 1/088

(57) ABSTRACT

A high-voltage high-speed switching apparatus includes a hydrogen fuel cell; an inverter configured to convert a DC voltage outputted from the hydrogen fuel cell into a three-phase AC voltage of a predetermined level; a voltage divider connected in parallel between output terminals of the hydrogen fuel cell and input terminals of the inverter; a switching control unit configured to compare an input voltage of the voltage divider and predetermined DC voltage reference values, and generate and output a plurality of switching control signals; a high-speed switching unit including first to mth switching channels that are connected in parallel to the voltage divider, each of the first to mth switching channels being controlled by a plurality of switching control signals to be switched; and a dummy load group configured with dummy loads that are independently connected to the first to mth switching channels, respectively.

### BACKGROUND

### 1. Technical Field

The present disclosure relates to a high-voltage high-speed switching apparatus for stabilizing the voltage of a hydrogen fuel cell and a control method thereof, and more particularly, to a high-voltage high-speed switching apparatus for stabilizing the voltage of a hydrogen fuel cell and a control method thereof, which safely maintain voltage in a hydrogen fuel cell system to protect a power conversion device and a fuel cell from an overvoltage.

### 2. Related Art

A hydrogen fuel cell system uses hydrogen to generate power, and generally includes a fuel cell stack in which a plurality of fuel cells are stacked. In order to prevent damage to the fuel cells and a power conversion device when a voltage excessively increases in the fuel cell stack, a protection system is required. In particular, when there is an open circuit voltage (OCV) in the fuel cell stack, the performance and lifespan of the fuel cells may decrease.

According to a conventional apparatus for converting power of a fuel cell for power generation illustrated in FIG. 1 (FIG. 2 of Korean Patent Laid-open Publication No. 10-2023-0123573), the apparatus includes a fuel cell 101, a first initial charge circuit 102, a dummy resistor 103, a DC input breaker 104, a power converter 106, a filter unit 107, an AC system breaker 108, a second initial charge circuit 109, and a system 110. The apparatus for converting power of a fuel cell for power generation includes a power converter configured to convert power generated by the fuel cell and supply the converted power to a system or load, and a controller configured to detect a failure occurring in the fuel cell, the power converter or the system or load while the fuel cell is driven and to reduce an open circuit voltage (OCV) of the fuel cell by a dummy resistor connected in parallel to output terminals of the fuel cell when a failure occurs in the fuel cell, the power converter or the system or load.

However, in the hydrogen fuel cell system that outputs a high voltage, because a maximum DC voltage is very high as 1,500 volts, simply connecting the dummy load as an existing chopper type configuration as in FIG. 1 cannot stabilize an overvoltage, and energy loss may be caused.

### PRIOR ART LITERATURES

### Patent Documents

Korean Patent Laid-open Publication No. 10-2023-0123573 entitled “Apparatus for Converting Power of Fuel Cell for Power Generation and Method thereof”
Korean Patent Laid-open Publication No. 10-2023-0109977 entitled “Grid-connected Inverter for Supporting Uninterruptible Power Supply Mode”
Korean Patent Laid-open Publication No. 10-2014-0041156 entitled “Power Conversion Device”
Korean Patent Laid-open Publication No. 10-2012-0061661 entitled “Fuel Cell System and Method for Controlling the Same”

### SUMMARY

An object of the present disclosure is to provide a high-speed switching apparatus and a control method thereof capable of stabilizing the high voltage of a hydrogen fuel cell by separately controlling the positive terminal side and the negative terminal side of a dummy load.

In an embodiment, a high-voltage high-speed switching apparatus for stabilizing the voltage of a hydrogen fuel cell may include: a hydrogen fuel cell; an inverter configured to convert a DC voltage outputted from the hydrogen fuel cell into a three-phase AC voltage of a predetermined level; a voltage divider connected in parallel between output terminals of the hydrogen fuel cell and input terminals of the inverter; a switching control unit configured to compare an input voltage of the voltage divider and predetermined DC voltage reference values, and generate and output a plurality of switching control signals; a high-speed switching unit including first to mth switching channels that are connected in parallel to the voltage divider, each of the first to mth switching channels being controlled by a plurality of switching control signals to be switched; and a dummy load group configured with dummy loads that are independently connected to the first to mth switching channels, respectively.

Preferably, the voltage divider may include first and second capacitors that are connected in parallel between the output terminals of the hydrogen fuel cell and the input terminals of the inverter and are connected in series to each other. One end of the first capacitor and one end of the second capacitor may be connected to a central node to be grounded, the other end of the first capacitor may be connected to a P node, and the other end of the second capacitor may be connected to an N node.

Preferably, each of the first to mth switching channels may include a top leg switching element section and a bottom leg switching element section that are connected in series. One end of the top leg switching element section and one end of the bottom leg switching element section may be connected to the central node to be grounded, the other end of the top leg switching element section may be connected to the P node, and the other end of the bottom leg switching element section may be connected to the N node.

Preferably, the switching control unit may simultaneously or selectively switch the first to mth switching channels depending on the level of an overvoltage outputted from the hydrogen fuel cell so that a load current amount flowing through the dummy load group is made the same or different depending on a time.

Preferably, when a voltage outputted from the hydrogen fuel cell is higher than a first DC voltage reference value, the switching control unit may perform turn-on operations simultaneously for the first switching channel to the mth switching channel. When a voltage outputted from the hydrogen fuel cell is higher than a second DC voltage reference value that is lower than the first DC voltage reference value, the switching control unit may perform a turn-on operation for the first switching channel, and when a voltage outputted from the hydrogen fuel cell is still higher than the second DC voltage reference value after a set predetermined delay time, the switching control unit may perform a turn-on operation for the second switching channel. When a voltage outputted from the hydrogen fuel cell is lower than a third DC voltage reference value, the switching control unit may perform a turn-off operation for the mth switching channel, and when a voltage outputted from the hydrogen fuel cell is still lower than the third DC voltage reference value after a set predetermined delay time, the switching control unit may perform a turn-off operation for an (m−1)th switching channel.

In an embodiment, there may be provided a method for controlling a high-voltage high-speed switching apparatus for stabilizing the voltage of a hydrogen fuel cell, including a hydrogen fuel cell; an inverter configured to convert a DC voltage outputted from the hydrogen fuel cell into a three-phase AC voltage of a predetermined level; a voltage divider connected in parallel between output terminals of the hydrogen fuel cell and input terminals of the inverter; a switching control unit configured to compare an input voltage of the voltage divider and predetermined DC voltage reference values, and generate and output a plurality of switching control signals; a high-speed switching unit including first to mth switching channels that are connected in parallel to the voltage divider, each of the first to mth switching channels being controlled by a plurality of switching control signals to be switched; and a dummy load group configured with dummy loads that are independently connected to the first to mth switching channels, respectively, wherein the switching control unit simultaneously or selectively switches the first to mth switching channels depending on the level of an overvoltage outputted from the hydrogen fuel cell so that a load current amount flowing through the dummy load group is made the same or different depending on a time.

Preferably, when a voltage outputted from the hydrogen fuel cell is higher than a first DC voltage reference value, the switching control unit may perform turn-on operations simultaneously for the first switching channel to the mth switching channel. When a voltage outputted from the hydrogen fuel cell is higher than a second DC voltage reference value that is lower than the first DC voltage reference value, the switching control unit may perform a turn-on operation for the first switching channel, and when a voltage outputted from the hydrogen fuel cell is still higher than the second DC voltage reference value after a set predetermined delay time, the switching control unit may perform a turn-on operation for the second switching channel. When a voltage outputted from the hydrogen fuel cell is lower than a third DC voltage reference value, the switching control unit may perform a turn-off operation for the mth switching channel, and when a voltage outputted from the hydrogen fuel cell is still lower than the third DC voltage reference value after a set predetermined delay time, the switching control unit may perform a turn-off operation for an (m−1)th switching channel.

According to the high-voltage high-speed switching apparatus for stabilizing the voltage of a hydrogen fuel cell and the control method thereof of the present disclosure, by separately controlling the positive terminal side and the negative terminal side of a dummy load, it is possible to stabilize the high voltage of a hydrogen fuel cell.

In addition, according to the present disclosure, since a topology in which half bridges are connected in series is provided for a high DC voltage outputted from a hydrogen fuel cell, a switching element with a low voltage capacity may be used, which is advantageous for high voltage generation of a hydrogen fuel cell system.

Moreover, according to the present disclosure, by using the switching element with a low voltage capacity, the stability of the hydrogen fuel cell system may be improved.

### BRIEF DESCRIPTION OF THE DRAWINGS

FIG. 1 is a detailed configuration diagram of an apparatus for converting power of a fuel cell for power generation according to a prior art.

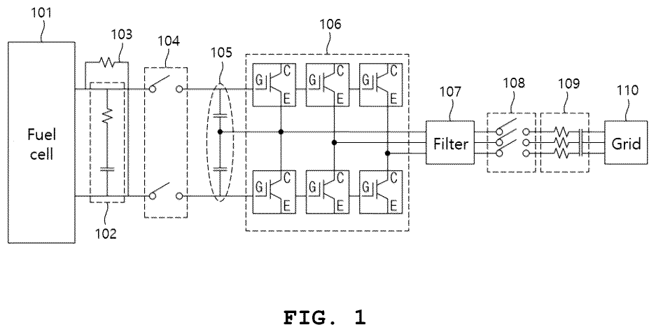

FIG. 2 is a block configuration diagram of a high-voltage high-speed switching apparatus for stabilizing the voltage of a hydrogen fuel cell according to an embodiment of the present disclosure.

FIG. 3 is a switching timing diagram for a single channel of the high-voltage high-speed switching apparatus for stabilizing the voltage of a hydrogen fuel cell according to the embodiment of the present disclosure.

FIG. 4 is a switching timing diagram for a plurality of channels of the high-voltage high-speed switching apparatus for stabilizing the voltage of a hydrogen fuel cell according to the embodiment of the present disclosure.

FIG. 5 is another switching timing diagram for a plurality of channels of the high-voltage high-speed switching apparatus for stabilizing the voltage of a hydrogen fuel cell according to the embodiment of the present disclosure.

### DETAILED DESCRIPTION

Additional objects, features and advantages of the present disclosure will be understood more clearly from the following detailed description and accompanying drawings.

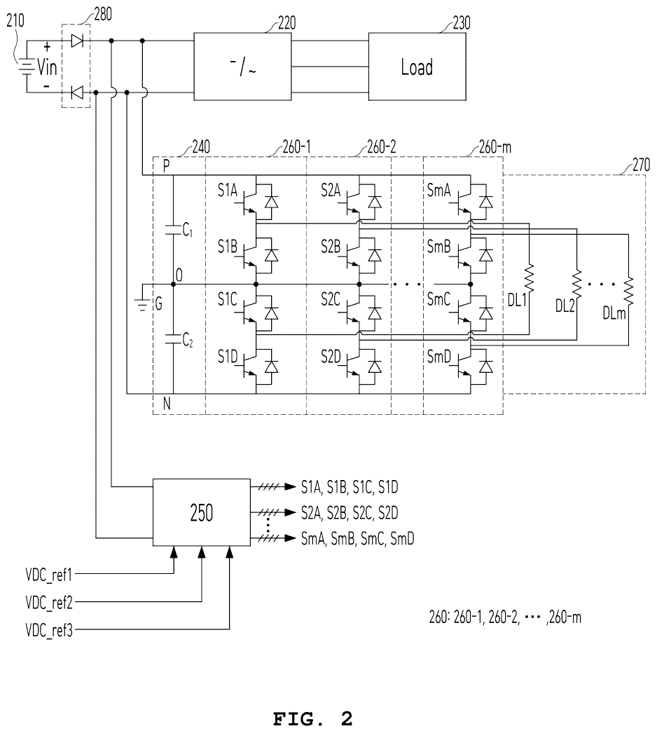

FIG. 2 is a block configuration diagram of a high-voltage high-speed switching apparatus for stabilizing the voltage of a hydrogen fuel cell according to an embodiment of the present disclosure.

The high-voltage high-speed switching apparatus for stabilizing the voltage of a hydrogen fuel cell according to the embodiment of the present disclosure includes a hydrogen fuel cell 210, an inverter 220, a load 230, a voltage divider 240, a switching control unit 250, a high-speed switching unit 260, a dummy load group 270, and a protection diode 280.

The hydrogen fuel cell 210 according to the embodiment of the present disclosure may output up to DC 1,500 volts.

The inverter 220 according to the embodiment of the present disclosure converts a DC voltage outputted from the hydrogen fuel cell 210 into a three-phase AC voltage of a predetermined level and outputs the three-phase AC voltage.

The load 230 according to the embodiment of the present disclosure may be a load that consumes the output power of the inverter 220 by itself or a system that is connected to the inverter 220 via a circuit breaker (CB).

The voltage divider 240 according to the embodiment of the present disclosure includes first and second capacitors C1 and C2 that are connected in parallel between the output terminals of the hydrogen fuel cell 210 and the input terminals of the inverter 220 and are connected in series to each other. The first and second capacitors C1 and C2 may divide an output voltage Vin outputted from the hydrogen fuel cell 210 each into half (½Vin), i.e., 750 volts. One end of the first capacitor C1 and one end of the second capacitor C2 are connected to a central node O to be grounded to a ground G, the other end of the first capacitor C1 is connected to a node P, and the other end of the second capacitor C2 is connected to a node N.

The switching control unit 250 according to the embodiment of the present disclosure compares the input voltage Vin of the voltage divider 240 and predetermined DC voltage reference values VDC_ref1, VDC_ref2 and VDC_ref3, and generates and outputs switching signals S1A, S1B, S1C, S1D, S2A, S2B, S2C, S2D, . . . , SmA, SmB, SmC and SmD for first to mth switching channels 260-1, 260-2, . . . and 260-m.

The high-speed switching unit 260 according to the embodiment of the present disclosure includes the first to mth switching channels 260-1, 260-2, . . . and 260-m that are connected in parallel to the voltage divider 240. Each of the first to mth switching channels 260-1, 260-2, . . . and 260-m includes a top leg switching element section and a bottom leg switching element section that are connected in series, and one end of the top leg switching element section and one end of the bottom leg switching element section are connected to the central node O to be grounded.

The switching periods of the first to mth switching channels 260-1, 260-2, . . . and 260-m may be the same as or different from each other.

The dummy load group 270 may include first to mth dummy loads DL1, DL2, . . . and DLm to discharge a massive overvoltage of the hydrogen fuel cell 210.

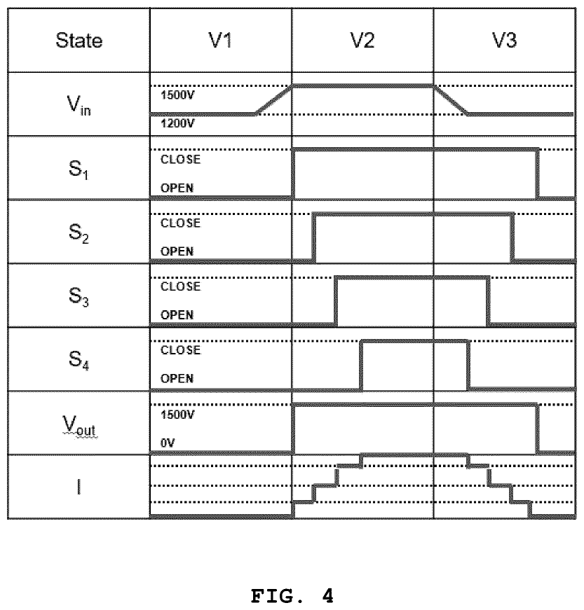

For example, when the first to mth switching channels 260-1, 260-2, . . . and 260-m are switched during the same period, a load current may flow for the same period of time through the first to mth dummy loads DL1, DL2, . . . and DLm. In addition, when the first to mth switching channels 260-1, 260-2, . . . and 260-m are switched during different periods, a total load current flowing through the first to mth dummy loads DL1, DL2, . . . and DLm may be different depending on a time as shown in FIG. 4.

The protection diode 280 is composed of a pair of diodes that are coupled in a forward direction from the hydrogen fuel cell 210 toward the load 230, and may protect the hydrogen fuel cell 210 from the load 230 when the voltage of the load 230 (e.g., a system) is higher than the voltage of the hydrogen fuel cell 210 and thus a reverse voltage is applied toward the hydrogen fuel cell 210.

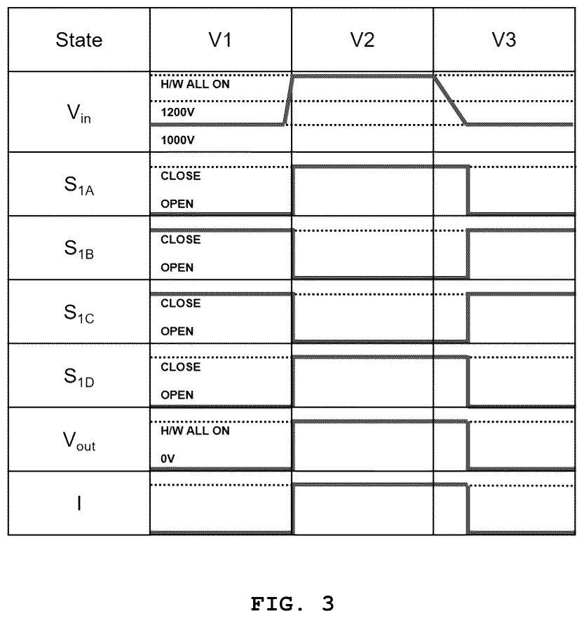

FIG. 3 is a switching timing diagram for a single channel of the high-voltage high-speed switching apparatus for stabilizing the voltage of a hydrogen fuel cell according to the embodiment of the present disclosure.

When the input voltage Vin of the voltage divider 240, which is the output voltage of the hydrogen fuel cell 210, becomes an overvoltage state, an upper switching element S1A of the top leg switching element section and a lower switching element S1D of the bottom leg switching element section are turned on, and a dummy load current flows through the dummy load DL1 and thus a dummy load voltage Vout is outputted.

The upper switching element S1A and a lower switching element S1B of the top leg switching element section and the lower switching element S1D and an upper switching element S1C of the bottom leg switching element section operate alternately.

That is to say, when the upper switching element S1A of the top leg switching element section is turned on, the lower switching element S1B of the top leg switching element section is turned off, and when the lower switching element S1D of the bottom leg switching element section is turned on, the upper switching element S1C of the bottom leg switching element section is turned off.

In this way, since a topology in which half bridges are connected in series is provided for a high DC voltage outputted from the hydrogen fuel cell 210, a switching element with a low voltage capacity may be used, which is advantageous for high voltage generation of a hydrogen fuel cell system. Moreover, by using the switching element with a low voltage capacity, the stability of the hydrogen fuel cell system may be improved.

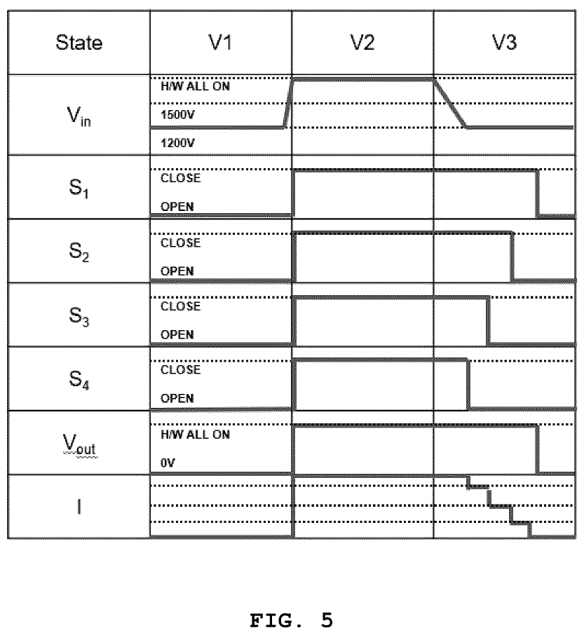

FIG. 4 is a switching timing diagram for a plurality of channels of the high-voltage high-speed switching apparatus for stabilizing the voltage of a hydrogen fuel cell according to the embodiment of the present disclosure, and FIG. 5 is another switching timing diagram for a plurality of channels of the high-voltage high-speed switching apparatus for stabilizing the voltage of a hydrogen fuel cell according to the embodiment of the present disclosure.

Depending on the level of an overvoltage outputted from the hydrogen fuel cell 210, by simultaneously or selectively switching the first to mth switching channels 260-1, 260-2, . . . and 260-m, a total load current amount flowing through the first to mth dummy loads DL1, DL2, . . . and DLm may be made the same or different depending on a time.

When an overvoltage outputted from the hydrogen fuel cell 210 is higher than the predetermined second DC voltage reference value VDC_ref2, a turn-on operation may be performed for the first switching channel 260-1 to connect the first switching channel 260-1 to a dummy load. When an overvoltage outputted from the hydrogen fuel cell 210 is still higher than the predetermined second DC voltage reference value VDC_ref2 after a set predetermined delay time, a turn-on operation may be performed for the second switching channel 260-2 to connect the second switching channel 260-2 to a dummy load. Such turn-on operations for switching channels may be performed sequentially up to the mth switching channel 260-m. The second DC voltage reference value VDC_ref2 is lower than the first DC voltage reference value VDC_ref1.

Conversely, when a voltage outputted from the hydrogen fuel cell 210 is lower than the predetermined third DC voltage reference value VDC_ref3, a turn-off operation may be performed for the mth switching channel 260-m to disconnect the mth switching channel 260-m from a dummy load. When a voltage outputted from the hydrogen fuel cell 210 is still lower than the predetermined third DC voltage reference value VDC_ref3 after a set predetermined delay time, a turn-off operation may be performed for the (m−1)th switching channel 260-m−1 to disconnect the (m−1)th switching channel 260-m−1 from a dummy load. Such turn-off operations for switching channels may be performed sequentially down to the first switching channel 260-1.

Accordingly, as shown in FIG. 4, as the number of switching channels turned on increases, a dummy load current I_DL flowing through dummy loads gradually increases. When the number of switching channels turned on reaches a maximum, the dummy load current I_DL maintains a maximum value, and as the number of switching channels turned on decreases, the dummy load current I_DL gradually decreases.

Meanwhile, as shown in FIG. 5, when an overvoltage outputted from the hydrogen fuel cell 210 is higher than the predetermined first DC voltage reference value VDC_ref1, turn-on operations may be performed simultaneously for the first switching channel 260-1 to the mth switching channel 260-m to connect the first switching channel 260-1 to the mth switching channel 260-m to dummy loads. Thereafter, when a voltage outputted from the hydrogen fuel cell 210 is lower than the predetermined third DC voltage reference value VDC_ref3, a turn-off operation may be performed for the mth switching channel 260-m to disconnect the mth switching channel 260-m from a dummy load. When a voltage outputted from the hydrogen fuel cell 210 is still lower than the predetermined third DC voltage reference value VDC_ref3 after a set predetermined delay time, a turn-off operation may be performed for the (m−1)th switching channel 260-m−1 to disconnect the (m−1)th switching channel 260-m−1 from a dummy load. Such turn-off operations for switching channels may be performed sequentially down to the first switching channel 260-1.

Four switching elements provided in one channel in FIG. 4 and FIG. 5 operate alternately as shown in FIG. 3. For example, a person skilled in the art may understand that FIG. 4 represents that the switching elements S1A and S1D are turned on and the switching elements S1B and S1C are turned off during a corresponding period and that the switching elements S1A, S1B, S1C and S1D are not turned on at the same time.

What is claimed is:

1. A high-voltage high-speed switching apparatus for stabilizing the voltage of a hydrogen fuel cell, the apparatus comprising:
a hydrogen fuel cell;
an inverter configured to convert a DC voltage outputted from the hydrogen fuel cell into a three-phase AC voltage of a predetermined level;
a voltage divider connected in parallel between output terminals of the hydrogen fuel cell and input terminals of the inverter;
a switching control unit configured to compare an input voltage of the voltage divider and predetermined DC voltage reference values, and generate and output a plurality of switching control signals;
a high-speed switching unit including first to mth switching channels that are connected in parallel to the voltage divider, each of the first to mth switching channels being controlled by a plurality of switching control signals to be switched; and
a dummy load group configured with dummy loads that are independently connected to the first to mth switching channels, respectively.

2. The high-voltage high-speed switching apparatus according to claim 1, wherein
the voltage divider includes first and second capacitors that are connected in parallel between the output terminals of the hydrogen fuel cell and the input terminals of the inverter and are connected in series to each other, and
one end of the first capacitor and one end of the second capacitor are connected to a central node to be grounded, the other end of the first capacitor is connected to a P node, and the other end of the second capacitor is connected to an N node.

3. The high-voltage high-speed switching apparatus according to claim 2, wherein
each of the first to mth switching channels includes a top leg switching element section and a bottom leg switching element section that are connected in series, and
one end of the top leg switching element section and one end of the bottom leg switching element section are connected to the central node to be grounded, the other end of the top leg switching element section is connected to the P node, and the other end of the bottom leg switching element section is connected to the N node.

4. The high-voltage high-speed switching apparatus according to claim 3, wherein the switching control unit simultaneously or selectively switches the first to mth switching channels depending on the level of an overvoltage outputted from the hydrogen fuel cell so that a load current amount flowing through the dummy load group is made the same or different depending on a time.

5. The high-voltage high-speed switching apparatus according to claim 4, wherein
when a voltage outputted from the hydrogen fuel cell is higher than a first DC voltage reference value, the switching control unit performs turn-on operations simultaneously for the first switching channel to the mth switching channel,
when a voltage outputted from the hydrogen fuel cell is higher than a second DC voltage reference value that is lower than the first DC voltage reference value, the switching control unit performs a turn-on operation for the first switching channel, and when a voltage outputted from the hydrogen fuel cell is still higher than the second DC voltage reference value after a set predetermined delay time, the switching control unit performs a turn-on operation for the second switching channel, and
when a voltage outputted from the hydrogen fuel cell is lower than a third DC voltage reference value, the switching control unit performs a turn-off operation for the mth switching channel, and when a voltage outputted from the hydrogen fuel cell is still lower than the third DC voltage reference value after a set predetermined delay time, the switching control unit performs a turn-off operation for an (m−1)th switching channel.

6. A method for controlling a high-voltage high-speed switching apparatus for stabilizing the voltage of a hydrogen fuel cell, including a hydrogen fuel cell; an inverter configured to convert a DC voltage outputted from the hydrogen fuel cell into a three-phase AC voltage of a predetermined level; a voltage divider connected in parallel between output terminals of the hydrogen fuel cell and input terminals of the inverter; a switching control unit configured to compare an input voltage of the voltage divider and predetermined DC voltage reference values, and generate and output a plurality of switching control signals; a high-speed switching unit including first to mth switching channels that are connected in parallel to the voltage divider, each of the first to mth switching channels being controlled by a plurality of switching control signals to be switched; and a dummy load group configured with dummy loads that are independently connected to the first to mth switching channels, respectively,
wherein the switching control unit simultaneously or selectively switches the first to mth switching channels depending on the level of an overvoltage outputted from the hydrogen fuel cell so that a load current amount flowing through the dummy load group is made the same or different depending on a time.

7. The method according to claim 6, wherein
when a voltage outputted from the hydrogen fuel cell is higher than a first DC voltage reference value, the switching control unit performs turn-on operations simultaneously for the first switching channel to the mth switching channel,
when a voltage outputted from the hydrogen fuel cell is higher than a second DC voltage reference value that is lower than the first DC voltage reference value, the switching control unit performs a turn-on operation for the first switching channel, and when a voltage outputted from the hydrogen fuel cell is still higher than the second DC voltage reference value after a set predetermined delay time, the switching control unit performs a turn-on operation for the second switching channel, and
when a voltage outputted from the hydrogen fuel cell is lower than a third DC voltage reference value, the switching control unit performs a turn-off operation for the mth switching channel, and when a voltage outputted from the hydrogen fuel cell is still lower than the third DC voltage reference value after a set predetermined delay time, the switching control unit performs a turn-off operation for an (m−1)th switching channel.
